(19) United States
(12) Patent Application Publication
(10) Pub. No.: US 2008/0301055 A1
(43) Pub. Date: Dec. 4, 2008

(54) UNIFIED PLATFORM FOR REPUTATION AND SECURE TRANSACTIONS

(75) Inventors: Christian Herwarth Borgs, Seattle, WA (US); Jennifer Tour Chayes, Seattle, WA (US); Nicole S. Immorlica, Seattle, WA (US); Kamal Jain, Bellevue, WA (US); Vahab Mirrokni, Seattle, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/755,987

(22) Filed: May 31, 2007

(51) Int. Cl. G06Q 30/00; H04L 9/32

(52) U.S. Cl. 705/64; 705/26

(57) ABSTRACT

The claimed subject matter provides a unified platform system and/or a method that facilitates optimizing an online transaction. The unified platform system can include a secured transaction component that can secure a portion of transactional data related to an online transaction between at least one buyer and at least one merchant utilizing a secure transaction technique. The unified platform system can include a reputation assessment component that can receive a portion of reputation data related to at least one of the buyer or the merchant based at least in part upon verifying completion of the online transaction between such buyer and merchant. The unified platform system can publish the portion of reputation data coupled with a portion of non-private transactional data to provide context for the reputation data.

### BACKGROUND

Computing and network technologies have transformed many aspects of everyday life. Computers have become household staples rather than luxuries, educational tools and/or entertainment centers, and provide individuals and corporations with tools to manage and forecast finances, control operations such as heating, cooling, lighting and security, and store records and images in a permanent and reliable medium. Networking technologies like the Internet provide individuals virtually unlimited access to remote systems, information and associated applications.

As computing and network technologies have evolved and have become more robust, secure and reliable, more consumers, wholesalers, retailers, entrepreneurs, educational institutions and the like are shifting paradigms and are employing the Internet to perform business rather traditional means. For example, today consumers can access their bank accounts on-line (e.g., via the Internet) and can perform an ever growing number of banking transactions such as balance inquiries, fund transfers, bill payments, and the like.

Typically, an on-line session can include individuals interfacing with client applications (e.g., web services) to interact with a database server that stores information in a database accessible to client applications. For instance, a stock market web site can provide users with tools to retrieve stock quotes and purchase stock. Users can enter stock symbols and request stock quotes by performing mouse clicks to activate a query. Client applications can then query databases containing stock information and return appropriate stock quotes. Users, based on returned stock quote information, can thereafter purchase or sell stocks by supplying suitable information, wherein submitting buy or sell orders initiate database queries to return current pricing information and order status.

Based on the ever-increasing use of the computer and/or the Internet, numerous transactions related to goods, services, and/or commerce have become common place in an online environment. Yet, with the vast possibilities of the Internet, a plethora of concerns and/or suspicions can arise for a user and/or client contemplating to purchase an item, good, service, etc. over the Internet. In particular, the reputation or lack thereof related to a seller and/or buyer involved in a transaction is a major concern in light of the various complications that can arise in completing a transaction. In addition to the numerous fears and/or doubts associated with potential merchants (e.g., websites, individuals, online stores, etc.), consumers are typically weary to transmit/communicate account information or other security sensitive information in order to participate in these online transactions.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate coupling secured transactions with reputation assessments related to an online transaction. A unified platform system can integrate and/or tightly couple secured transaction techniques with reputation assessment in order to enhance traditional online transactions and feedback mechanisms. The unified platform system can include a secure transaction component and a reputation assessment component, wherein the combination of such components into a unified platform system provides consumers and companies with a one-stop shopping service and further enables a powerful reputation mechanism that accounts for consumer spending in the weights assigned to their ratings. In particular, the unified platform system can verify the transfer of funds between parties involved in a transaction and provide such transaction details (e.g., price, costs, date, etc.) with collected reputation data (e.g., feedback, comments, reports, etc.) to provide context for merchant/buyer evaluations.

The secure transaction component can receive a portion of transactional data and/or enable payment/funds to be securely transferred between two parties. The secure transaction component can further protect the transactional data to ensure such data is not threatened by theft or fraud and, in general, kept private. Upon verification of completion of the transaction and/or transfer of funds between a buyer and a merchant, the reputation assessment component can collect and/or gather reputation data associated with at least one of the buyer or the merchant. The reputation data can be published to an online environment (e.g., a website, a network, a server, a machine, a computer, etc.). Specifically, the reputation data can include non-private transactional data such as price, costs, date, time, etc. to provide context for the collected reputation data. In other aspects of the claimed subject matter, methods are provided that facilitate verifying the completion of a secured transaction to enable reputation assessment for one of a buyer or a merchant involved with an online transaction.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates coupling secured transactions with reputation assessments related to an online transaction.

FIG. 2 illustrates a block diagram of an exemplary system that facilitates verifying the completion of a secured transaction to enable reputation assessment for one of a buyer or a merchant involved with an online transaction.

FIG. 3 illustrates a block diagram of an exemplary system that facilitates allowing reputation data related to verified online transactions to be utilized by potential consumers to assist in evaluating a potential merchant.

FIG. 4 illustrates a block diagram of an exemplary system that facilitates utilizing an operating system to provide secure transactions which can be verified to enable the gathering of reputation data.

FIG. 5 illustrates a block diagram of exemplary system that facilitates combining secured transactions with reputation assessments in order to enhance online transactions.

FIG. 6 illustrates a block diagram of an exemplary system that facilitates receiving reputation data related to at least one of a buyer or a merchant based upon the validation of currency exchange between the buyer and the merchant.

FIG. 7 illustrates an exemplary methodology for verifying the completion of a secured transaction to enable reputation assessment for one of a buyer or a merchant involved with an online transaction.

FIG. 8 illustrates an exemplary methodology that facilitates allowing reputation data related to verified online transactions to be utilized by potential consumers to assist in evaluating a potential merchant.

FIG. 9 illustrates an exemplary networking environment, wherein the novel aspects of the claimed subject matter can be employed.

FIG. 10 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “application,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

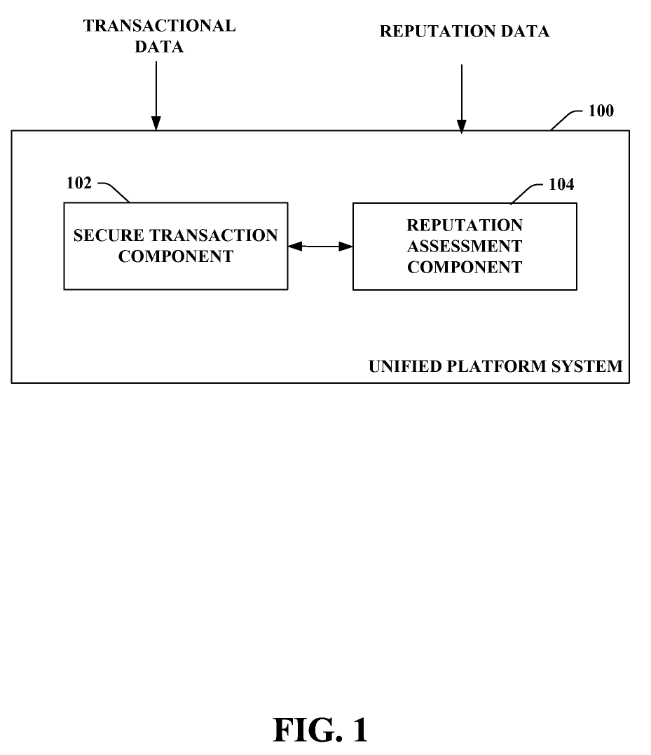

Now turning to the figures, FIG. 1 illustrates a unified platform system 100 that facilitates coupling secured transactions with reputation assessments related to an online transaction. The unified platform system 100 can tightly couple secured transactions with reputation assessments associated with online transactions between at least one buyer and at least one merchant. The unified platform system 100 can exploit the synergy between reputation mechanisms and secure transaction mechanisms utilized in connection with an online transaction. Conventionally, a secure transaction mechanism is completely independent of a reputation assessment mechanism. However, the unified platform system 100 combines secure transactions with reputation assessment in order to enhance online transactions. In particular, the unified platform system 100 can verify currency exchange between a buyer and a merchant prior to allowing an evaluation of a party's reputation. Moreover, the unified platform system 100 can provide transaction details (e.g., cost, product, date, etc.) for context related to reputation data related to a buyer or a merchant. By verifying actual currency exchange and including transaction details, reputation assessment for an online transaction between a buyer and a merchant is more accurate and useful to assist potential buyers with future potential online transactions.

The unified platform system 100 can include a secure transaction component 102 that receives a portion of transactional data and/or enables a payment to be securely transferred between two parties. The secure transaction component 102 can protect the transactional data to ensure such data is not threatened by theft or fraud and, in general, kept private. The secure transaction component 102 can employ most any suitable technique to protect transactional data such as, but not limited to, username and passwords, security tokens, digital identity, digital signatures, private keys, certificates, Security Assertion Markup Language (SAML), an OASIS industry standard, username, X.509 certificates, Kerberos tickets, encryption techniques, server authentication, message integrity check, client authentication, a third-party verification service, public key cryptography, etc. In general, the secure transaction component 102 can protect transactional data associated with at least one of a buyer or a merchant, wherein such transactional data can be related to personal information (e.g., name, age, address, social security number, driver's license number, gender, phone number, height, weight, etc.), financial information (bank name, credit card type, account holder, etc.), payment type (e.g., credit card, cash on delivery (COD), check, money order, credit card, virtual credit card (discussed in more detail below), etc.), account information (e.g., routing number, check number, credit card number, account holder, etc.), credit card data (e.g., credit card number, expiration date, account holder, card limit, etc.), cost of good/service, shipping costs, a time of purchase, a date of purchase, and/or most any suitable data related to an online transaction.

The unified platform system 100 can further include a reputation assessment component 104 that can collect buyer or merchant evaluations related to an online transaction. In general, the reputation assessment component 104 can receive reputation data associated with an online transaction (e.g., between a purchaser and a merchant) based at least in part upon verification that the online transaction has occurred. By tightly coupling the reputation assessment component 104 with the secure transaction component 102, the unified platform system 100 can ensure online transactions are secure and genuine reputation data is collected. Thus, the reputation assessment component 104 can collect evaluations related to parties in a transaction upon the secured transaction being completed by the secure transaction component 102. In other words, once a secure transaction has occurred between a buyer and a merchant utilizing the secure transaction component 102, the reputation component 104 can enable reputation data to be gathered related to such verified online transaction. By providing such transactional data and verifying completion of a transaction, the reputation assessment component 104 provides context and more accurate/genuine reputation data for merchants and/or buyers. Conventionally, whether a transaction has occurred is unknown in relation to traditional electronic feedback systems/techniques (e.g., auction sites, merchant websites, etc.). It is to be appreciated that the reputation data can be most any suitable data related to the evaluation of a party involved with an online transaction such as feedback from a buyer or feedback from a merchant. For instance, a buyer might leave positive feedback for a merchant for a particular transaction such as “Great job, pleasure to do business with.”

Furthermore, once the reputation data is collected and/or gathered, the reputation assessment component 104 can implement a timed delay for release and/or exposure to the parties involved. For example, a buyer and a seller can complete an online transaction in which both provide reputation data. The reputation assessment component 104 can enforce a delay before the buyer or the seller are exposed to their respective reputation data, thereby eliminating tick-for-tack rating (e.g., buyer provides negative feedback which allows seller to provide negative feedback in retaliation). It is to be appreciated that the reputation assessment component 104 can enforce most any suitable amount of delay (e.g., minutes, hours, days, weeks, months, etc.) which can restrict at least the buyer or the seller/merchant involved in the transaction. However, the reputation assessment component 104 can allow disparate buyers and/or sellers/merchants to be exposed to such reputation data to enable real-time evaluation of buyers, merchants, etc.

In addition, the unified platform system 100 can include any suitable and/or necessary interface component (not shown), which provides various adapters, connectors, channels, communication paths, etc. to integrate the unified platform system 100 into virtually any operating and/or database system(s) and/or with one another. In addition, the interface component can provide various adapters, connectors, channels, communication paths, etc., that provide for interaction with the secure transaction component 102, the reputation assessment component 104, and/or most any suitable component associated with the unified platform system 100.

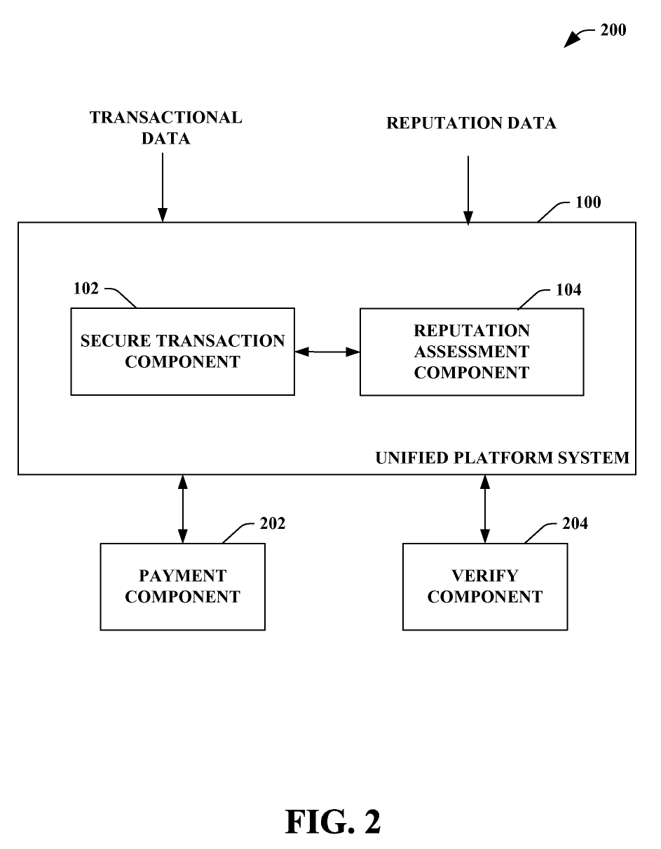

FIG. 2 illustrates a system 200 verifying the completion of a secured transaction to enable reputation assessment for one of a buyer or a merchant involved with an online transaction. The system 200 can include the unified platform system 100 which integrates secure transactions and reputation assessment mechanisms to enable enhanced online transactions between a buyer and a merchant. The unified platform system 100 includes several consequences and several advantages. For example, unifying reputation and secure transactions into a single platform simplifies the transaction process for consumers, merchants, companies, etc. Moreover, by linking and/or tightly coupling the reputation mechanism (e.g., the reputation assessment component 104) to the payment mechanism (e.g., the secure transaction component 102), the unified platform system 100 can enable reputation providers to account for transaction amounts in their rating systems. The unified platform system 100 can be less susceptible to fraud in which a company and/or merchant boosts its reputation with small transactions and then defaults on a large transaction, as often occurs with traditional auction websites and/or auction-based reputation systems.

The system 200 can further utilize a payment component 202. The payment component 202 can facilitate transferring funds between a buyer and a merchant. For instance, the system 200 can leverage the payment component 202 to enable fund transfer between a purchaser and a seller for a particular good/service in relation to a specific transaction. The payment component 202 can be, but is not limited to being, a bank, a bank account, an online account, a saving account, a checking account, an account, a credit card company, a debit card company, a virtual credit card business, a virtual credit card account, a money order service, most any suitable entity capable of employing the transfer of funds between parties. It is to be appreciated that the payment component 202 can be seamlessly utilized in connection with the secure transaction component 102, wherein the secure transaction component 102 can provide security and/or protection for a transaction and the payment component 202 can enable funds to be transferred between two parties.

Furthermore, the system 200 can utilize a verify component 204 that verifies data associated with the online transaction between a buyer and a merchant. In general, the verify component 204 can be utilized by the unified platform system 100 to provide digital infrastructure that enables and protects interactions across voice and/or data networks by validating identities of users, machines, clients, etc. For example, the verify component 204 can ensure data integrity and/or identities related to communications between a buyer and a seller/merchant involved with an online transaction. Moreover, the verify component 204 can validate claims and/or rights associated with an online transaction (e.g., identity and/or reputation of merchant, identify and/or reputation of consumer/buyer, a right to buy a good at a price, right to rate the merchant after transaction completion, most any suitable aspect related to a transaction that can be verified and/or ensured valid, website verification, secured transaction service verification, verification of transaction completion, etc.).

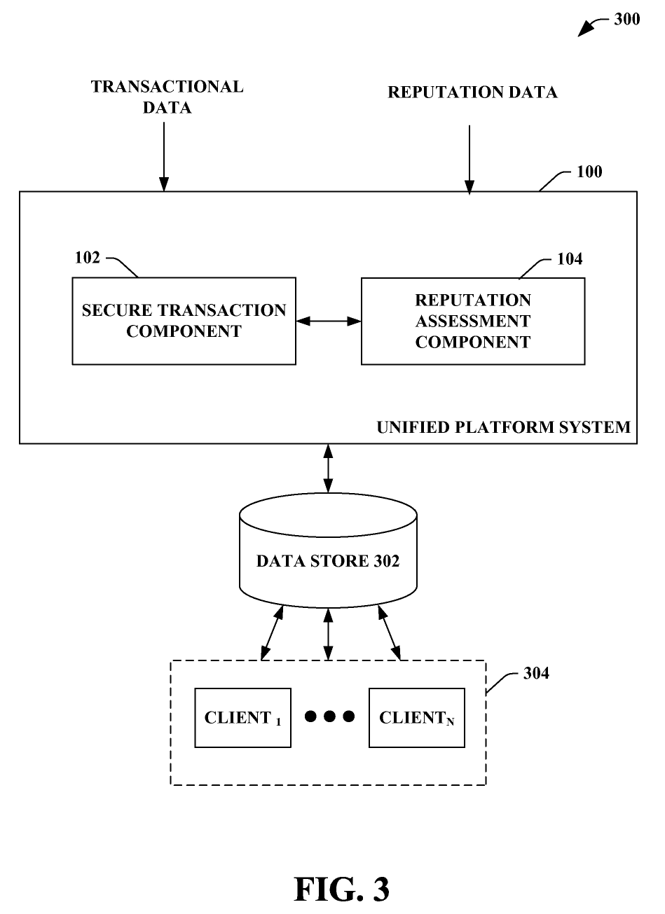

FIG. 3 illustrates a system 300 that facilitates allowing reputation data related to verified online transactions to be utilized by potential consumers to assist in evaluating a potential merchant. The system 300 can include the unified platform system 100 that tightly couples a secure transaction and a reputation assessment in order to enhance and optimize online transactions between a buyer and a merchant. As discussed, the unified platform system 100 can allow reputation data to be collected with contextual background (e.g., reputation data coupled with verified transactional data and/or transactional details such as price, quantity, date, etc.). In other words, the unified platform system 100 can enable a unique reputation assessment in relation to online transactions based on verification of a transaction between a buyer and a merchant as well as details and/or context surrounding such transaction. It is to be appreciated that such transactional details and/or data coupled to the reputation assessment can be filtered and/or structured to exclude private data and/or sensitive data.

The system 300 can further include a data store 302 that can include any suitable data related to the unified platform system 100, the secure transaction component 102, the reputation assessment component 104, etc. For example, the data store 302 can include, but not limited to including, transactional data, reputation data, personal information (e.g., name, age, address, social security number, driver's license number, gender, phone number, height, weight, etc.), financial information (bank name, credit card type, account holder, etc.), payment type (e.g., credit card, cash on delivery (COD), check, money order, credit card, virtual credit card (discussed in more detail below), etc.), account information (e.g., routing number, check number, credit card number, account holder, etc.), credit card data (e.g., credit card number, expiration date, account holder, card limit, etc.), most any suitable data related to an online transaction, buyer evaluations, merchant evaluations, buyer information (e.g., name, address, duration of identity, etc.), merchant information (e.g., name, address, duration of identity, etc.), buyer ranking/assessment, merchant ranking/assessment, transactional history for buyer, transactional history for merchant, etc.

It is to be appreciated that the data store 302 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 302 of the subject systems and methods is intended to comprise, without being limited to, these and any other suitable types of memory. In addition, it is to be appreciated that the data store 302 can be a server, a database, a hard drive, a pen drive, an external hard drive, a portable hard drive, and the like.

With the collection and gathering of unique reputation assessment data (e.g., unique based on the coupling of transactional data and the verifying of the completion of the transaction), the system 300 can facilitate distributing reputation data to various individuals, clients, users, groups, websites, servers, companies, businesses, and the like. It is to be appreciated that the distribution and/or publication of reputation data can be limited to the collected evaluations of buyers and/or sellers in order to ensure the privacy of sensitive data and/or protect account information. In other words, the system 300 can provide distribution of evaluations, feedback, reputation assessments, etc. related to an online transaction while filtering out private data (e.g., address, phone, social security number, height, weight, etc.) and/or account data (account number, credit card number, virtual credit card number, etc.). Thus, the reputation data included within the data store 302 can be distributed to clients 304, wherein there can be most any suitable number of clients such as client₁ to client_{N} with N being a positive integer. It is to be appreciated that the distribution of such unique reputation assessment data coupled with transactional details can be offered to such clients 304 as a service in order to educate and/or inform such clients for future online transactions. For example, a potential buyer can locate an item on a merchant website, but may be unfamiliar with such merchant. The system 300 can provide a report and/or the reputation data associated with the merchant website in order to provide the potential buyer with insight on reputation assessments with transactional details (but not including private and/or account information). It is to be appreciated that the report and/or reputation data can be provided for free or a nominal fee (e.g., monthly fee, pay per use basis, etc.).

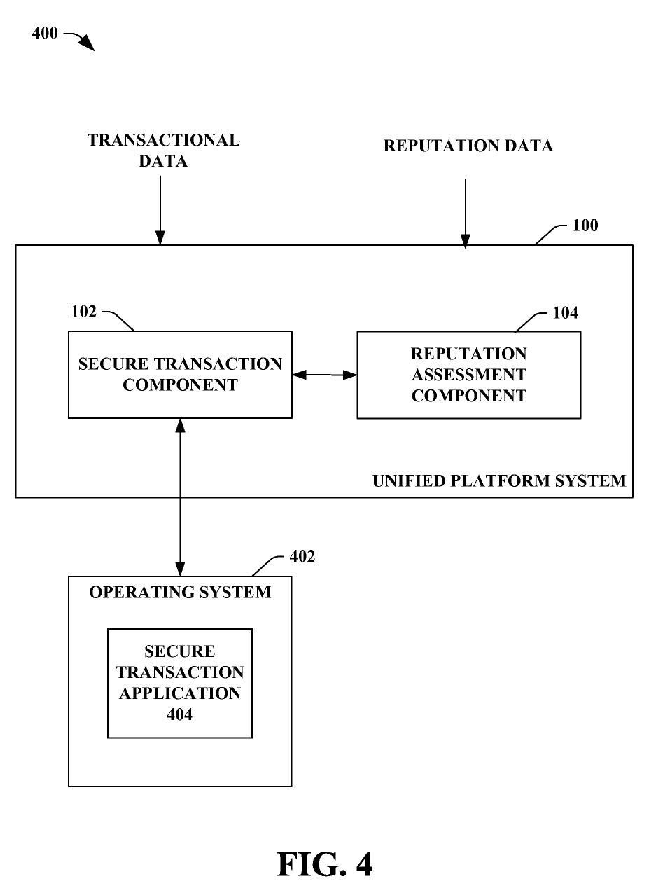

FIG. 4 illustrates a system 400 that facilitates utilizing an operating system to provide secure transactions which can be verified to enable the gathering of reputation data. The system 400 can couple a secure transaction with reputation assessment in order to employ an optimized online transaction having accurate merchant and/or buyer evaluation and/or feedback. The system 400 can include the unified platform system 100 that tightly couples and/or integrates the secure transaction component 102 and the reputation assessment component 104, wherein the unified platform system 100 can provide consumers and companies alike with a one-stop shopping service and further enable powerful reputation systems which account for consumer spending in the weights assigned to their rankings.

The system 400 can leverage an operating system (OS) 402 in order to optimize an online transaction between a buyer and a merchant. For example, the OS 402 can be a set of computer programs that manage a portion of hardware or software resources of a computer, machine, etc. Furthermore, the OS 402 can perform basic tasks such as, but not limited to, controlling and allocating memory, prioritizing system requests, controlling input and output devices, facilitating networking, managing file systems, etc. Additionally, the OS 402 can be most any suitable operating system that includes a secure transaction application 404. The secure transaction application 404 can be a portion of hardware and/or software that can be leveraged by the unified platform system 100 in order to tightly couple secure transactions and reputation assessment. In other words, the system 400 can utilize most any secure transaction technique and/or mechanism (e.g., the secure transaction component 102, the secure transaction application 404, a secure transaction technique as described in FIG. 1, etc.).

For example, the secure transaction application 404 can employ a dynamic functionality which allows users to create verifiable claims about certain static information, such as credit card numbers, login identifications (IDs), passwords, etc. on electronic “cards.” These cards can be exchanged across the Internet and the claims verified at a secure site run by a verifier (e.g., the verify component discussed above). The secure transaction application 404 can include dynamic claims such as reputation, the price of a transaction, the limits on the time an offer is valid, and/or most any suitable information related to an online transaction. Dynamic claims regarding a user can be changed by that user during transactions with other users in order to dynamically adapt to particular details for specific transactions. Additionally, a user may grant another user the “right” to amend a claim on his/her card, as in the case of a reputation assessment. The system 400 can also utilize one-time tokens, which can prevent unauthorized reuse of a one-time authorization. In one example, a virtual credit card can be utilized to complete fund transfer for the online transaction. The virtual credit card can be a temporary account number/holder with particular details (e.g., amount, time limit, specific payee, etc.), wherein the temporary account number/holder is tied and/or linked to a master account. By utilizing the virtual credit card, the master account and associated data is shielded from being exposed to the payee and/or other potential identity thieves. In other words, the master account can spawn various virtual credit cards with each having specific details related thereto in order to mask the true information/data related to the master account. Moreover, claims, rights, one-time tokens, and/or most any data related to the online transaction can be encrypted, digitally signed, and/or most any suitable security technique to prevent misuse.

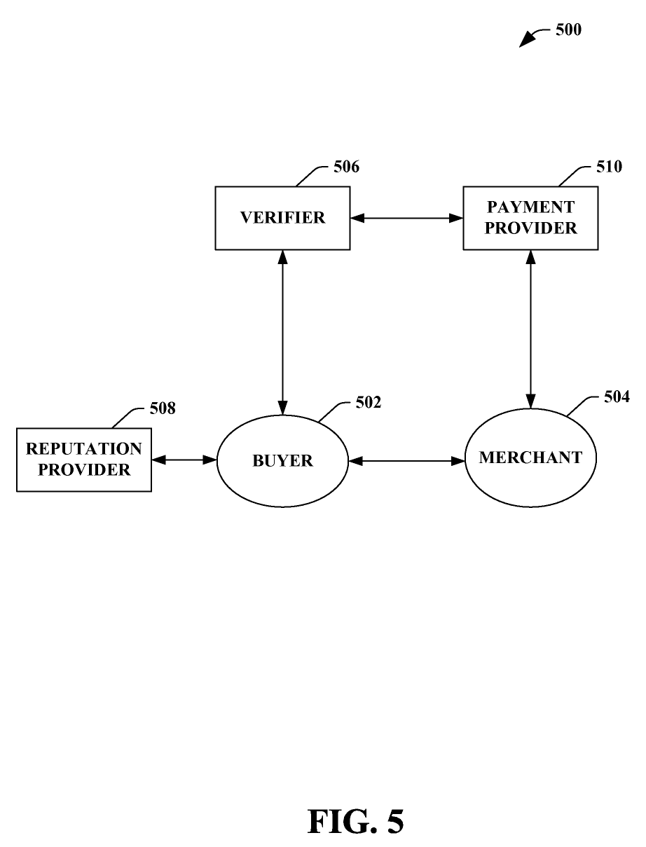

FIG. 5 illustrates a system 500 that facilities combining secured transactions with reputation assessments in order to enhance online transactions. The system 500 can include a potential buyer 502 who, possibly after some research, decides to perform a transaction with a merchant 504. The system 500 provides an insight on the interactions with various entities associated with the online transaction utilizing the subject innovation that couples secured transactions and reputation assessment. The merchant 504 can send the buyer 502 a card with at least one of a claim or a right. For instance, the claims and rights can be the following: a claim concerning identify and/or reputation of the merchant 504; a right to buy a good at some price (e.g., possibly with some time limit); or a right to rate the merchant 504 after the transaction is complete. It is to be appreciated the above claims and/or rights are for example and are not to be exclusive or exhaustive. Moreover, the claims and/or rights can be optional (e.g., the merchant 504 can opt out of the rating system at the risk of reducing the consumer's trust in the claimed reputation, etc.).

The buyer 502 can receive the card from the merchant 504 and contact a verifier 506. The verifier 506 can verify the contents of the card. The buyer 502 can contact a reputation provider 508 to inquire about the merchant 504 reputation. Based on the response from the reputation provider 508, the buyer 502 can decide whether or not to buy the item/service from the merchant 504. The buyer 502 can append to the card a claim regarding account information (e.g., checking account, credit card, virtual credit card, etc.). For instance, the claim may not include account number itself, but rather the right for a particular entity (in this case a payment provider 510) to read the account number. The buyer can send the combined card back to the merchant 504 in which the merchant 504 has a card verifying the right to charge the amount to the buyer 502 account.

The merchant 504 can forward the card to the payment provider 510. The payment provider 510 can contact the verifier 506 to check the contents of the card (e.g., in particular the credit card number of the buyer 502). The verifier 506 can further give the payment provider 510 the actual account number of the buyer 502 as well as the actual account number of the merchant 504. The payment provider 510 can bill the buyer 502 account the amount of the item/service which is credited to the merchant 504 account. It is to be appreciated that the verifier 506 account can receive a portion of the price/amount for the item/service as a commission. The payment provider 510 can confirm the completion of the transaction with the verifier 506 (e.g., possibly with the use of another card). The verifier 506 can send a card with a receipt to at least one of the merchant 504 or the buyer 502. The verifier 506 can also provide the buyer 502 with the suitable rating rights for the merchant 504 including an expiration date. Moreover, the merchant 504 can be given the right to rate the buyer 502. The buyer 502 can rate the merchant 504 and append the rating to the card with the receipt proclaiming his rating rights, and forwards the combined card to, for instance, a rating site. If agreed, the merchant 504 can send his rating of the buyer to the rating site as well. The rating site can be dynamically updated with the reputation of the merchant 504 and/or the buyer 502 accordingly. It is to be appreciated that a secure server is utilized for the payment provider 510 and/or the verifier 506.

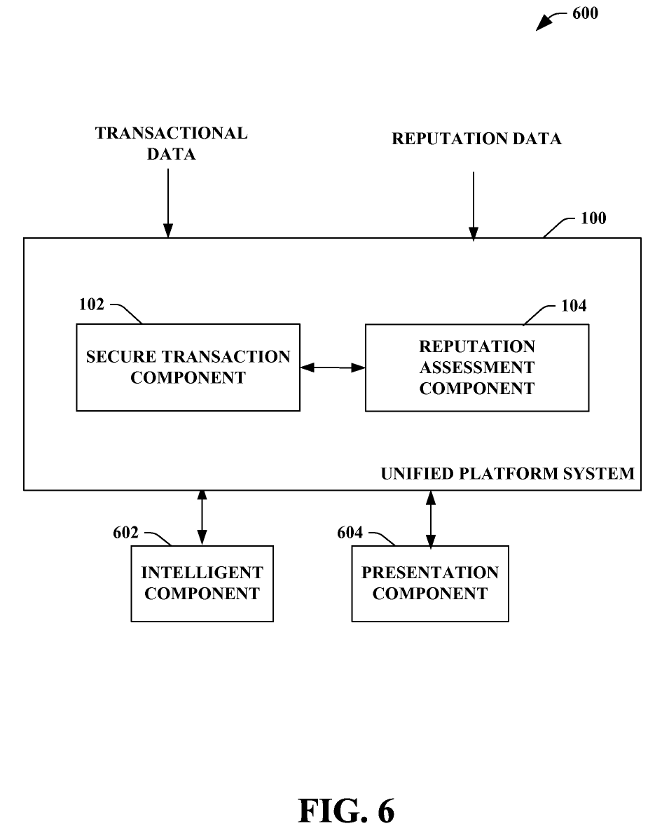

FIG. 6 illustrates a system 600 that employs intelligence to facilitate receiving reputation data related to at least one of a buyer or a merchant based upon the validation of currency exchange between the buyer and the merchant. The system 600 can include the unified platform system 100 that integrates and/or combines a reputation assessment mechanism with a secure transaction mechanism, wherein such combination allows verification of transactions and transactional data/details to provide context for reputations/evaluations of merchants and/or buyers. In other words, the unified platform system 100 not only allows buyers and/or merchants to be rated and/or evaluated, but enables such rating/evaluation to be seen and/or utilized in light of transactional details such as verified completion of the transaction and/or costs/prices related to the transaction. The unified platform system 100 employs a realistic and accurate reputation assessment related to participants in a transaction that is less susceptible to fraud, increases feedback realism (e.g., reducing inflated/skewed ratings), and/or includes a weight factor that measures the importance of a rating for transactions (e.g., ratings associated with higher priced transactions have more weight).

The system 600 can include the unified platform system 100, the secure transaction component 102, and the reputation assessment component 104 which can be substantially similar to respective systems, and components described in previous figures. The system 600 further includes an intelligent component 602. The intelligent component 602 can be utilized by the unified platform system 100 to facilitate providing accurate reputation data and/or evaluations associated with at least one of a buyer or a merchant involved in an online transaction. For example, the intelligent component 602 can infer buyer claims, buyer preferences, buyer rights, buyer transactional preferences (e.g., type of account, shipping preferences, sale terms, etc.), merchant claims, merchant preferences, merchant rights, merchant transactional preferences (e.g., payments accepted, shipping costs, shipping type, etc.), rating preference (e.g., to be rated or not to be rated), price negotiation settings, etc.

It is to be understood that the intelligent component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

The unified platform system 100 can further utilize a presentation component 604 that provides various types of user interfaces to facilitate interaction between a user and any component coupled to the unified platform system 100. As depicted, the presentation component 604 is a separate entity that can be utilized with the unified platform system 100. However, it is to be appreciated that the presentation component 604 and/or similar view components can be incorporated into the unified platform system 100 and/or a stand-alone unit. The presentation component 604 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the unified platform system 100.

The user can also interact with the regions to select and provide information via various devices such as a mouse, a roller ball, a keypad, a keyboard, a pen and/or voice activation, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

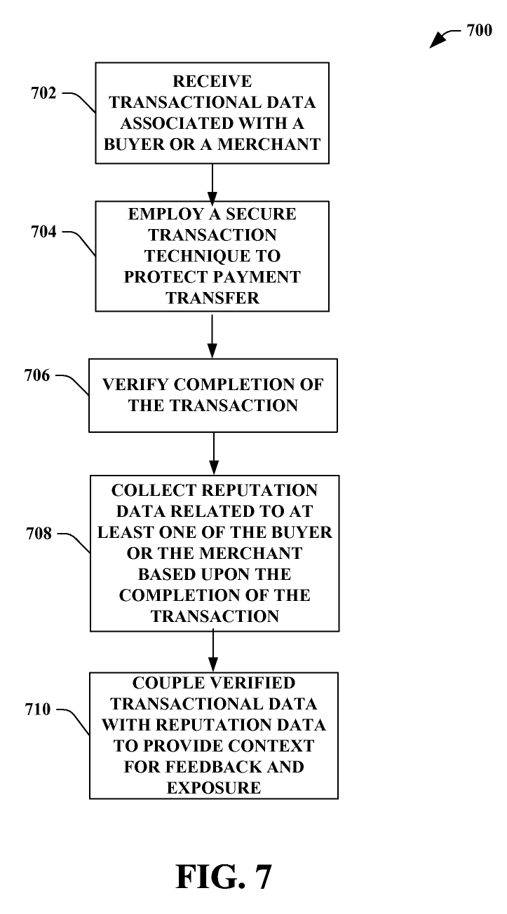

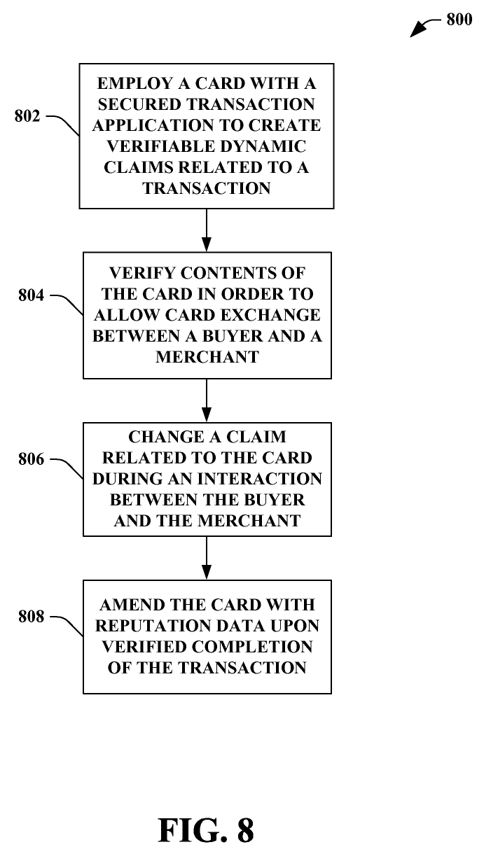

FIGS. 7-8 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 illustrates a method 700 that facilitates verifying the completion of a secured transaction to enable reputation assessment for one of a buyer or a merchant involved with an online transaction. At reference numeral 702, transactional data associated with a buyer or a merchant can be received. For example, the transactional data can be related to personal information (e.g., name, age, address, social security number, driver's license number, gender, phone number, height, weight, etc.), financial information (bank name, credit card type, account holder, etc.), payment type (e.g., credit card, cash on delivery (COD), check, money order, credit card, virtual credit card (discussed in more detail below), etc.), account information (e.g., routing number, check number, credit card number, account holder, etc.), credit card data (e.g., credit card number, expiration date, account holder, card limit, etc.), and/or most any suitable data related to an online transaction.

At reference numeral 704, a secure transaction technique can be employed to protect payment transfer. For instance, the payment transfer can be between a buyer and a merchant for a particular good and/or service. It is to be appreciated that most any secure transaction technique can be employed such as, but not limited to, username and passwords, security tokens, digital identity, digital signatures, private keys, certificates, Security Assertion Markup Language (SAML), an OASIS industry standard, username, X.509 certificates, Kerberos tickets, encryption techniques, server authentication, message integrity check, client authentication, a third-party verification service, public key cryptography, etc.

At reference numeral 706, the completion of the transaction between the buyer and the merchant can be verified. In other words, data integrity and/or identities related to communications between a buyer and a seller/merchant involved with an online transaction can be verified. At reference numeral 708, reputation data related to at least one of the buyer or the merchant can be collected based upon the verified completion of the transaction. In other words, the completion of a secure transaction between a buyer and a merchant can be verified, wherein reputation data can be collected upon the completion of such transaction. At reference numeral 710, the verified transactional data can be coupled with reputation data in order to provide context for feedback related to at least one of the buyer or the merchant. By providing such transactional data and verifying completion of a transaction, the reputation assessment and/or feedback can provide context and more accurate/genuine reputation data for merchants and/or buyers. The transactional data coupled with the reputation and/or evaluation for the buyer or the merchant can include cost of good/item/service, time, date, etc. Thus, the feedback and/or reputation assessment can account for transaction amounts in their rating systems in order to be less susceptible to fraud in which a company and/or merchant boosts its reputation with small transactions and then defaults on a large transaction. It is to be appreciated that such transactional details and/or data coupled to the reputation assessment can be filtered and/or structured to exclude private data and/or sensitive data. Moreover, such coupled data can be published to most any suitable online environment (e.g., the Internet, a website, a server, a network, a computer, a forum, a blog, a machine, etc.).

FIG. 8 illustrates a method 800 for allowing reputation data related to verified online transactions to be utilized by potential consumers to assist in evaluating a potential merchant. At reference numeral 802, a card can be employed with a secured transaction application to create verifiable dynamic claims related to an online transaction. For example, the card can include dynamic claims such as reputation, price of a transaction, limits on the time an offer is valid, etc. Moreover, it is to be appreciated that the secured transaction application can be associated with an operating system, a stand-alone portion of hardware and/or software, and/or most any suitable combination thereof. At reference numeral 804, content of the card can be verified in order to allow the exchange of cards between a buyer and a merchant. For example, the cards can be exchanged between a buyer and a merchant on the Internet, wherein claims associated with the cards can be verified at a secure site run by a verifier.

At reference numeral 806, a claim related to the card can be changed during an interaction and/or transaction between the buyer and the merchant. It is to be appreciated that a claim can be changed by either the buyer or the merchant in order to negotiate for the specific online transaction. At reference numeral 808, a card can be amended with reputation data upon verified completion of the transaction. The card can be amended with reputation data and/or feedback connected to the verified transaction. For example, a buyer's card can be amended with reputation data from a merchant upon the verified completion of a transaction there between. Moreover, the reputation data can include a portion of transactional data such as price, cost, shipping costs, time, date, good/service, user-defined details, etc. to provide context of feedback. It is to be appreciated that private data, account information, and/or other sensitive data can be excluded from being coupled and/or attached to the reputation assessment.

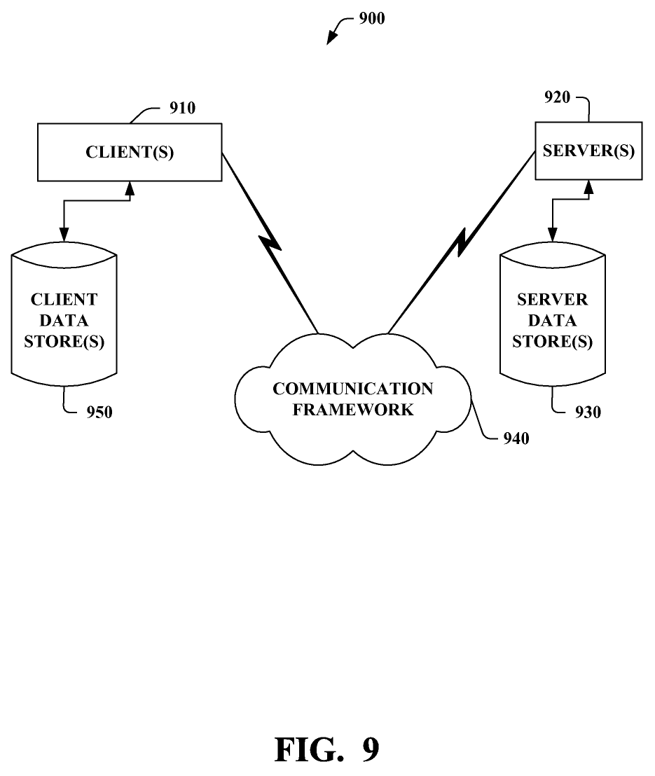

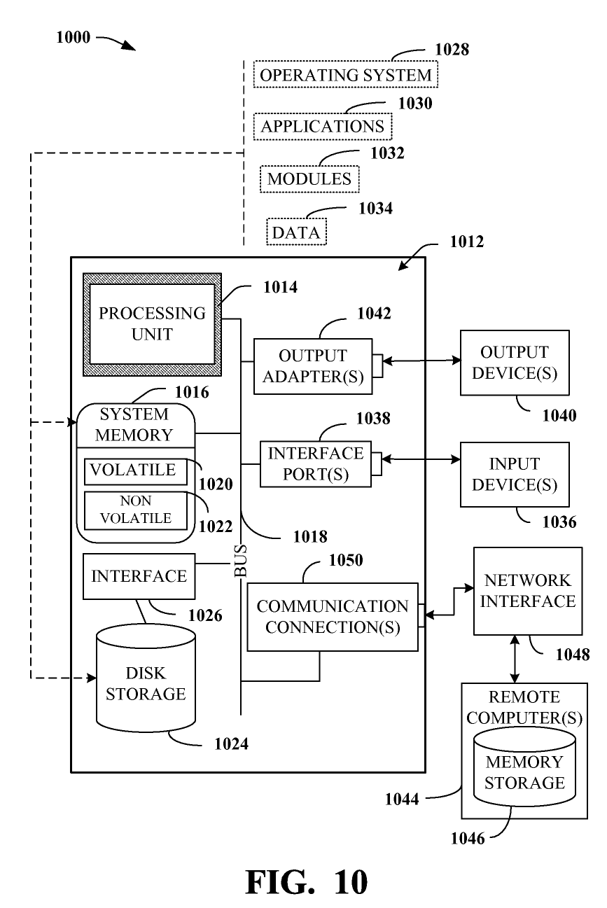

In order to provide additional context for implementing various aspects of the claimed subject matter, FIGS. 9-10 and the following discussion is intended to provide a brief, general description of a suitable computing environment in which the various aspects of the subject innovation may be implemented. For example, a unified platform system that facilitates coupling secured transactions with reputation assessment, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 9 is a schematic block diagram of a sample-computing environment 900 with which the claimed subject matter can interact. The system 900 includes one or more client(s) 910. The client(s) 910 can be hardware and/or software (e.g., threads, processes, computing devices). The system 900 also includes one or more server(s) 920. The server(s) 920 can be hardware and/or software (e.g., threads, processes, computing devices). The servers 920 can house threads to perform transformations by employing the subject innovation, for example.

One possible communication between a client 910 and a server 920 can be in the form of a data packet adapted to be transmitted between two or more computer processes. The system 900 includes a communication framework 940 that can be employed to facilitate communications between the client(s) 910 and the server(s) 920. The client(s) 910 are operably connected to one or more client data store(s) 940 that can be employed to store information local to the client(s) 910. Similarly, the server(s) 920 are operably connected to one or more server data store(s) 930 that can be employed to store information local to the servers 920.

With reference to FIG. 10, an exemplary environment 1000 for implementing various aspects of the claimed subject matter includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in the suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the claimed subject matter can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A unified platform system that facilitates employing an online transaction, comprising:
a secured transaction component that secures a portion of transactional data related to an online transaction between at least one buyer and at least one merchant utilizing a secure transaction technique;
a reputation assessment component that receives a portion of reputation data related to at least one of the buyer or the merchant based at least in part upon verifying completion of the online transaction between such buyer and merchant;
the secured transaction component and the reputation assessment component are tightly coupled to one another within the unified platform system; and
the unified platform system publishes the portion of reputation data coupled with a portion of non-private transactional data to provide context for the reputation data.

2. The unified platform system of claim 1, the transactional data is related to at least one of personal information, a name, an age, an address, a social security number, a driver's license number, a gender, a phone number, a height, a weight, financial information, a bank name, a credit card type, an account holder, a payment type, a credit card, a cash on delivery (COD), a check, a money order, virtual credit card, account information, a routing number, a check number, a credit card number, credit card data, an expiration date, a card limit, a cost of a good, a cost of a service, a time of purchase, a data of purchase, or a shipping cost.

3. The unified platform system of claim 1, the secure transaction technique is at least one of a username, a password, a security token, a digital identity, a digital signature, a private key, a certificate, a Security Assertion Markup Language (SAML), an OASIS industry standard, an X.509 certificate, a Kerberos ticket, an encryption technique, a server authentication, a message integrity check, a client authentication, a third-party verification service, or a public key cryptography.

4. The unified platform system of claim 1, the reputation data is at least one of an evaluation or a portion of feedback associated with at least one of the buyer in the transaction or the seller in the transaction.

5. The unified platform system of claim 1, the portion of non-private transactional data is at least one of a price related to the transaction, a data of purchase for the transaction, a time of purchase of the transaction, or a shipping cost related to the transaction.

6. The unified platform system of claim 5, the portion of reputation data coupled with the portion of non-private transactional data is made accessible to at least one client for a fee in order to assist in reviewing at least one of a potential buyer or a potential merchant.

7. The unified platform system of claim 1, the reputation assessment component implements a timed delay for publication of reputation data to at least one of the buyer or the seller involved in the transaction.

8. The unified platform system of claim 7, the timed delay is a period of time for at least one of the buyer or the merchant to independently generate a portion of feedback.

9. The unified platform system of claim 1, further comprising a payment component that facilitates transferring a portion of funds between the buyer and the merchant.

10. The unified platform system of claim 9, the payment component is at least one of a bank, a bank account, an online account, a saving account, a checking account, an account, a credit card company, a debit card company, a virtual credit card business, a virtual credit card account, a money order service, or an entity that employs a transfer of a portion of funds between parties.

11. The unified platform system of claim 1, further comprising a verify component that verifies a portion of data related to at least one of the transaction, the buyer or the merchant.

12. The unified platform system of claim 1, further comprising a secured transaction application that is leveraged to create a card with at least one of a verifiable claim or a verifiable right about at least one of static information or dynamic information.

13. The unified platform system of claim 12, the dynamic information relates to at least one of reputation, a price of a transaction, a limit on a time an offer is valid, a shipping cost, a shipping address, a term of sale, a feedback, or data related to a transaction between a buyer and a merchant.

14. The unified platform system of claim 12, the card is exchanged on the Internet for participation in a transaction and at least one of the verifiable claim or verifiable right is verified at a secure site run by a verify component.

15. The unified platform system of claim 12, at least one of the verifiable claim or the verifiable right is changed by a user involved with the transaction to allow negotiation.

16. The unified platform system of claim 12, the card is amended by a user at completion of a transaction to include at least one of an evaluation, a reputation assessment, or a portion of feedback.

17. A computer-implemented method that facilitates enhancing an online transaction, comprising:
receiving transactional data associated with a transaction between at least buyer and at least one merchant;
employing a secure transaction technique to protect payment transfer associated with the transaction;
verifying completion of the transaction;
collecting reputation data related to at least one of the buyer or the merchant based at least in part upon the completion of the transaction;
coupling verified transactional data with reputation data to provide context for feedback associated with at least one of the buyer or the merchant; and
publishing the verified transactional data coupled with reputation data to a portion of the Internet.

18. The method of claim 17, further comprising:
employing a card with a secured transaction application;
creating at least one verifiable dynamic claim related to a transaction on the card;
verifying contents of the card;
allowing the exchange of the card based at least in part upon the verification;
changing at least one verifiable dynamic claim during negotiations related to the transaction;
verifying exchange of currency between the buyer and the merchant; and
amending the card with reputation data based at least in part upon the verification of currency exchange.

19. The method of claim 17, further comprising exposing verified transactional data coupled with reputation data to at least one client for a fee in order to assist in reviewing at least one of a potential buyer or a potential merchant.

20. A computer-implemented system that facilitates enhancing an online transaction, comprising:
means for securing a portion of transactional data related to an online transaction between at least one buyer and at least one merchant utilizing a secure transaction technique;
means for receiving a portion of reputation data related to at least one of the buyer or the merchant based at least in part upon verifying completion of the online transaction between such buyer and merchant;
means for tightly coupling the secure transaction technique with the receipt of reputation data within a unified platform; and
means for publishing the portion of reputation data coupled with a portion of non-private transactional data to provide context for the reputation data.
